(19) United States
(12) Patent Application Publication
(10) Pub. No.: US 2020/0294172 A1
(43) Pub. Date: Sep. 17, 2020

(54) ADAPTIVE RESOURCE ALLOCATION

(71) Applicant: Walmart Apollo, LLC, Bentonville, AR (US)

(72) Inventors: Michael G. Ebener, JR., San Francisco, CA (US); Deepak R. Deshpande, San Jose, CA (US); Pratosh D. Rajkhowa, Sunnyvale, CA (US); Amritayan Nayak, Santa Clara, CA (US); Sandip Mahanta, Bangalore (IN)

(21) Appl. No.: 16/820,488

(22) Filed: Mar. 16, 2020

Related U.S. Application Data
(60) Provisional application No. 62/846,489, filed on May 10, 2019.

(30) Foreign Application Priority Data
Mar. 14, 2019 (IN) 201941009879

(51) Int. Cl. G06Q 50/28; G06Q 10/06; G06F 16/27; G06Q 30/02

(52) U.S. Cl. CPC G06Q 50/28; G06Q 30/0202; G06F 16/27; G06Q 10/06312

(57) ABSTRACT

Delivery blocks are generated to facilitate matching and assigning available delivery resources with expected delivery requirements for a given facility. These delivery blocks are generated by evaluating delivery forecast information for items to be delivered as a function of characterizing information for the delivery resources and delivery parameters corresponding to the given facility. Delivery blocks may include more than one delivery to a given delivery destination and instead may include a plurality of deliveries to various delivery destinations. Should a given delivery block that includes two or more delivery destinations require reassignment, that delivery block can be divided into child blocks that each provide for only a single delivery destination.

### RELATED APPLICATION(S)

This application claims the benefit of U.S. Provisional application No. 62/846,489, filed May 10, 2019 and of Indian Provisional application number 201941009879, filed Mar. 14, 2019, both of which are incorporated by reference in their entirety herein.

These teachings relate generally to the allocation of a resource to facilitate a corresponding task.

### BACKGROUND

One or more resources are typically required in order to effectuate a given task. For example, delivery resources are often employed to deliver items to specific delivery destinations. In cases where there is not a pre-existing dedicated relationship between a given resource and a given task, the reliable, efficient, and effective assignment of resources can present a variety of challenges depending upon any number of factors that tend to characterize the application setting.

Consider, for example, the seemingly straightforward task of delivering physical items from a first location (such as a retail facility or a distribution center) to corresponding delivery destinations (such as homes and offices). As the number of items to be delivered increases, so too can the complexity of the delivery resource allocation problem. Much the same occurs as the number of delivery destinations increases. Other potentially complicating factors include foreseeability challenges, temporal limitations and requirements, and so forth.

As home delivery service increases with consumer interest, the number of delivery resource modalities is also increasing. Examples include but are not limited to facility-owned delivery resources, facility-related delivery resources (such as, for example, where associates of the facility make themselves available to deliver items even though such a task is not a part of their ordinary job description), third-party delivery services, and so-called crowd-sourced delivery paradigms. Accommodating one or more such opportunities can also increase the challenges associated with ensuring that delivery resources are available to meet delivery requirements in a satisfactory manner.

### BRIEF DESCRIPTION OF THE DRAWINGS

The above needs are at least partially met through provision of the adaptive resource allocation mechanism described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a flow diagram as configured in accordance with various embodiments of these teachings;

FIG. 4 comprises a flow diagram as configured in accordance with various embodiments of these teachings;

FIG. 5 comprises a flow diagram as configured in accordance with various embodiments of these teachings; and

FIG. 6 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments facilitate automatically scheduling delivery resources for a facility having items to deliver. By one approach the various steps, actions, and activities pertaining to this scheduling can be carried out by a control circuit.

By one approach the control circuit accesses a first set of rules that define a number of delivery blocks as a function, at least in part, of delivery forecast information for a given facility, characterizing information for the delivery resources, and delivery parameters corresponding to the given facility. The control circuit then accesses delivery forecast information for items at the first facility spanning a predetermined window of time and generates a plurality of delivery blocks for at least a portion of the predetermined window of time by evaluating the delivery forecast information for items at the first facility against the first set of rules, wherein at least one of the plurality of delivery blocks provides for deliveries of items from the facility to at least two separate delivery destinations.

By one approach the control circuit then accesses a list of available delivery resources and transmits future delivery opportunities to the available delivery resources on a delivery block-by-delivery block basis. The control circuit then receives individual responses from various ones of the available delivery resources that comprise either of an acceptance or a declination of a corresponding proffered one of the future delivery opportunities. So configured, the control circuit can largely or solely serve to facilitate creating, assigning, and managing delivery blocks to thereby provide an efficient and reliable basis for delivering items from the facility to corresponding delivery destinations during the predetermined window of time.

In some cases a delivery resource that accepted a given delivery opportunity may become unable to meet that responsibility for any of a variety of reasons. By one approach these teachings provide for receiving a message from such a delivery resource that comprises a cancellation of a previously accepted delivery opportunity. In some cases that previously accepted delivery opportunity corresponds to a delivery block having at least two separate delivery destinations. In such a case these teachings will accommodate accessing a second set of rules that govern reassignment of a previously accepted delivery opportunity as a function, at least in part, of dividing a delivery block having at least two separate delivery destinations into a plurality of child blocks wherein at least one (or, if desired, each) of the child blocks can have only one delivery destination.

The control circuit can then use the aforementioned second set of rules to create a plurality of child blocks from the delivery block that corresponds to the previously accepted delivery opportunity wherein at least one of the plurality of child blocks has only a single delivery destination. (By one approach, if desired, each of the plurality of child blocks has only a single delivery destination.) The control circuit then facilitates assigning delivery opportunities that correspond to each of the plurality of child blocks to available delivery resources on a child block-by-child block basis. The control circuit can then receive individual responses from various ones of the available delivery resources that comprise either of an acceptance or a declination of a corresponding one of the future delivery opportunities that correspond to one of the plurality of child blocks.

So configured, these teachings can readily accommodate changing circumstances that alter previously-established delivery arrangements.

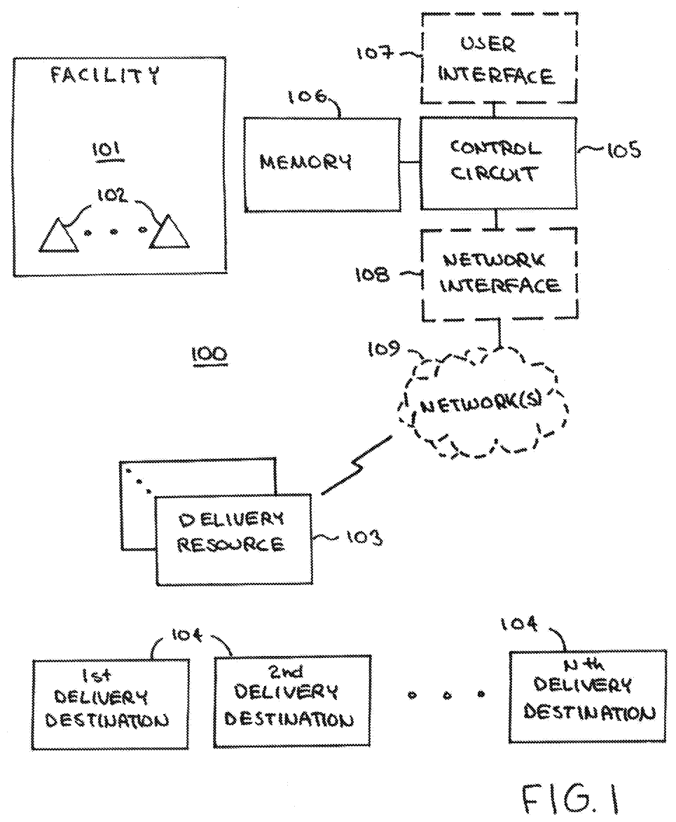

These and other benefits may become clearer upon making a thorough review and study of the following detailed description. Referring now to the drawings, and in particular to FIG. 1, an illustrative application setting 100 that is compatible with many of these teachings will be presented.

Generally speaking, these various embodiments presume a facility 101 having a plurality of items 102 available for delivery. It will be understood that these items 102 constitute physical things as versus digital or virtual things.

These teachings will accommodate a variety of different kinds of facilities. As one example, the facility 101 can comprise a retail shopping facility. Such a retail shopping facility can comprise a bricks-and-mortar (i.e., physical) facility in which products are physically displayed and offered for sale to customers who physically visit the facility. Such a retail shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility 101 may be any size or format of facility, and may include products from one or more merchants. For example, a facility may be a single store operated by one merchant or may be a collection of stores covering multiple merchants such as a mall.

As another example, the facility 101 may comprise a distribution center. As used herein the expression “distribution center” will be understood to refer to a physical facility (such as one or more buildings) where goods are received post-manufacture and then further distributed to a plurality of retail shopping facilities. A distribution center is not itself a retail shopping facility and instead serves as part of the supply chain that supplies retail shopping facilities with products to be sold at retail. A distribution center can serve as a warehouse by temporarily storing received items pending the distribution of such items to retail shopping facilities but in many cases products will not be warehoused in a traditional sense and will instead be moved from a receiving area to a dispersal area to minimize the time during which the distribution center possesses such items. In a typical application setting the distribution center and the corresponding retail shopping facilities will be co-owned/operated by a same enterprise.

And as yet another example, the facility 101 may comprise a warehouse that holds the items 102 pending an order by a consumer or other end-user for a particular stored item 102.

In this illustrative example the application setting 100 includes a plurality of delivery resources 103. These teachings will accommodate a variety of different delivery modalities, all of which are physical rather than digital or virtual in nature and which are manmade and configured to physically convey a physical item from one physical location to another. Physically speaking, these delivery resources 103 may comprise one or more of trucks and vans, automobiles, motorcycles, bicycles, and airborne vehicles, to note but a few examples. Operationally speaking, these delivery resources 103 may be owned and operated by the enterprise that owns and operates the facility 101, or the delivery resources 103 may be owned and operated by third parties that are unrelated to the foregoing enterprise. For example, by one approach a single third-party, such as an integrated delivery service, owns and operates a fleet of such delivery resources 103. By another approach, a third-party (such as Uber or Lyft) provides an interface and gateway to a community of privately owned and operated delivery resources. By yet another approach, some or all of the delivery resources 103 are owned and operated by individual third parties who simply contract and work for delivery services in their own regard. The present teachings will certainly accommodate other approaches in the foregoing regards as well.

This illustrative example presumes that the aforementioned items 102 are available for delivery to any of a plurality of delivery destinations 104. These delivery destinations 104 may be any physical location including but not limited to residences, offices, and/or commercial or industrial locations. Generally speaking, in a typical application setting these delivery destinations 104 will be within a generally or specifically circumscribed service area for the facility 101 (such as a service area defined by a political boundary or by a specified distance from the facility 101). (This example does not require that all of the items 102 at the facility 101 must be available for delivery to a delivery destination 104.)

This illustrative example further presumes that such deliveries are predicated upon one or more ordering processes. Various ordering processes are known in the art. Because these teachings are not overly sensitive to any particular approaches in those regards, further details in those regards are not provided here for the sake of brevity.

By one approach the application setting 100 further includes a control circuit 105. Being a “circuit,” the control circuit 105 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 105 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 105 is configured (for example, by using corresponding programming as will be well understood by those skilled in the art) to carry out one or more of the steps, actions, and/or functions described herein.

In this illustrative example the control circuit 105 operably couples to a memory 106. This memory 106 may be integral to the control circuit 105 or can be physically discrete (in whole or in part) from the control circuit 105 as desired. This memory 106 can also be local with respect to the control circuit 105 (where, for example, both share a common circuit board, chassis, power supply, and/or housing) or can be partially or wholly remote with respect to the control circuit 105 (where, for example, the memory 106 is physically located in another facility, metropolitan area, or even country as compared to the control circuit 105).

In addition to storing information regarding delivery forecast information for one or more facilities, characterizing information for a relevant pool of delivery resources, and delivery parameters corresponding to one or more facilities, this memory 106 can serve, for example, to non-transitorily store the computer instructions and rules described herein that, when executed by the control circuit 105, cause the control circuit 105 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

By one optional approach the control circuit 105 operably couples to a user interface 107. This user interface 107 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

By another optional approach, in lieu of or in combination with the foregoing, the control circuit 105 also operably couples to a network interface 108. So configured the control circuit 105 can communicate via one or more communications/data networks 109 with other elements (such as the above-mentioned delivery resources 103) via the network interface 108. Network interfaces, including both wireless and non-wireless platforms, are well understood in the art and require no particular elaboration here.

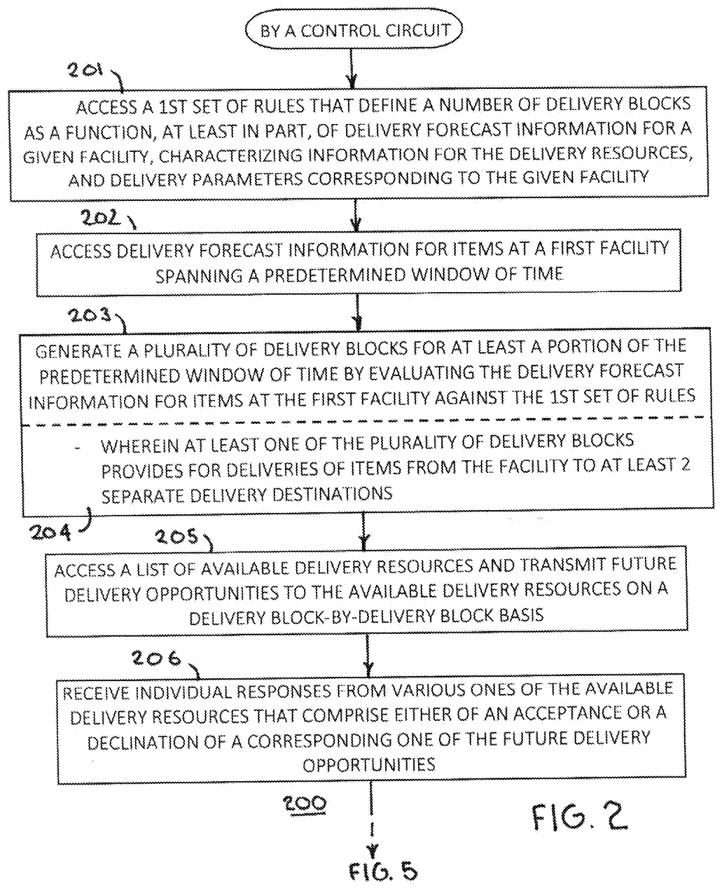

Many of the activities and functionality described herein can be carried out by the aforementioned control circuit 105 in such an application setting 100. That said, those skilled in the art will understand and recognize that the specific details of the foregoing application setting 100 are not to be viewed as constituting limitations as regards these teachings. Referring now to FIG. 2, a process 200 that can be carried out by the aforementioned control circuit 105 will be described.

At block 201, the control circuit 105 accesses (for example, via the aforementioned memory 106) a first set of rules. This first set of rules defines a number of delivery blocks as a function, at least in part, of delivery forecast information for a given facility, characterizing information for the delivery resources that are potentially available for scheduling such deliveries, and delivery parameters corresponding to the given facility.

The aforementioned characterizing information for the delivery resources can comprise, for example, an average number of items that can be simultaneously carried by a representative delivery resource (such as, for example, three or four items), a maximum volume of contents that can be simultaneously carried by the representative delivery resource, and/or a maximum weight of contents that can be simultaneously carried by the representative delivery resource. Such information can be ascertained and calculated by the enterprise that owns and operates the facility 101, or can be provided from one or more other reliable sources as desired. These teachings will accommodate other characterizing information that may be appropriate to consider in a given application setting.

The aforementioned delivery parameters that correspond to the given facility can comprise, for example, a first parameter representing an average length of time to complete a delivery of an item from the first facility (for example, 18 minutes, 30 minutes, and so forth) and/or a second parameter representing a maximum number of deliveries to be permitted per delivery block (for example, three deliveries, eight deliveries, and so forth). Generally speaking, these delivery parameters serve to represent the particular circumstances of a given facility and its corresponding permitted/potential delivery destinations and can reflect such things as local distances, typical travel times, delivery destination density, access restrictions (owing, for example, to deliveries within a gated community), and so forth.

At block 202, the control circuit 105 accesses (for example, by accessing the aforementioned memory 106) delivery forecast information for items at the facility 101 spanning a predetermined window of time (such as an upcoming week, two contiguous weeks, or some other specified number of contiguous or non-contiguous days). This delivery forecast information can comprise, for example, a forecast of how many of the items 102 will need to be delivered from the facility 101 during that predetermined window of time. By one approach this forecast comprises a forecast of how many of the items 102 will need to be delivered from the facility 101 during the predetermined window of time on a per diem basis.

By one approach this forecast is based upon already-received orders. By another approach, this forecast is based, in whole or in part, upon predicted orders, in which case the forecast may be partially or wholly based upon historical ordering records for the facility 101. These teachings will also accommodate using both already-received orders in combination with predicted orders to formulate this forecast.

At block 203 the control circuit 105 then generates a plurality of delivery blocks for at least a portion of the predetermined window of time by evaluating the delivery forecast information for items at the facility 101 against the aforementioned first set of rules. In some cases, and as denoted by reference numeral 204, at least one of the plurality of delivery blocks provides for delivery of items from the facility to at least two separate delivery destinations.

Generally speaking, each generated delivery block represents a corresponding window of time. More particularly, a delivery block is a block of contiguous time during which a delivery person(s) executes tasks related to a delivery for the facility 101. A single delivery block can include multiple trips and/or multiple customer orders. This may also be referred to as a driver-shift in some instances. Viewed another way, a delivery block is a window of time for which a delivery person accepts delivery work and for which the delivery person is likely compensated.

By one approach, the overall delivery window is partitioned into a series of timeslots. These timeslots can have the same duration or not as desired. By one approach each time slot is one hour in length and begins on the hour. Delivery blocks can be generated to begin at the beginning of a particular timeslot, but may have a duration that is less than the timeslot, equal to the timeslot, or greater than the timeslot as desired.

The blocks may all have a same such window of time or may differ from one another in these regards. By one approach the delivery blocks are temporally sequential and leave no unallocated periods of time. By another approach, these teachings will accommodate allowing windows of time that are not included within any of the generated delivery blocks.

By one approach, the control circuit 105 provides a corresponding unique block identifier for each of the generated delivery blocks. By one approach this unique block identifier can comprise a numeric, alphabetic, or alphanumeric string of characters as desired. By one approach, the control circuit 105 also maintains, for each of the generated delivery blocks, a status indicator. This status indicator can indicate, at least in some cases, a usage status for the corresponding delivery block. These teachings will accommodate establishing and maintaining other metadata for some or all of the generated delivery blocks as desired.

So configured, the control circuit 105 therefore generates a number of delivery blocks well-suited to effect delivery of the forecast number of items to be delivered as a function of the aforementioned characterizing information for the delivery resources as well as delivery parameters corresponding to the facility 101. Accordingly, these teachings will accommodate varying the number of generated delivery blocks and/or the duration of such delivery blocks. These teachings will also accommodate, if desired, generating delivery blocks that overlap in whole or in part with other generated delivery blocks to accommodate particularly busy windows of time.

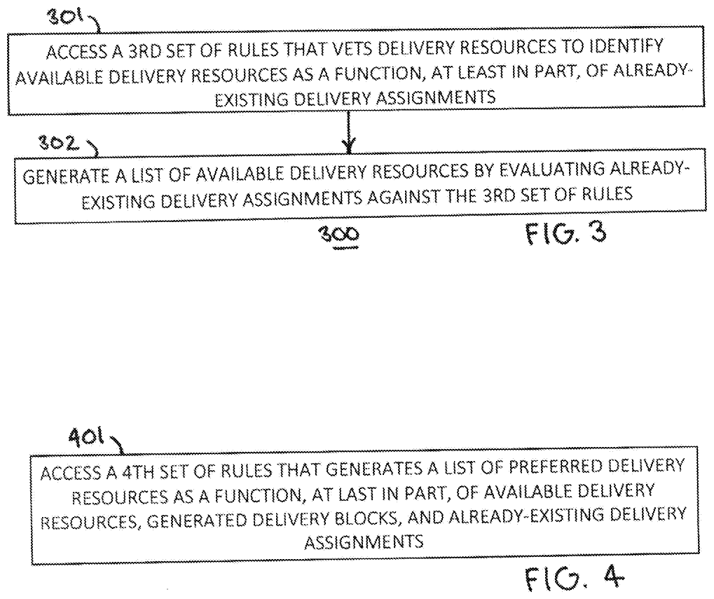

As will be described momentarily, this process 200 can make deliberate use of a list of available delivery resources to facilitate assigning available delivery blocks. Referring momentarily to FIG. 3, by one optional approach 300 the control circuit 105 can access, at block 301, a third set of rules that vet candidate delivery resources to thereby identify available delivery resources as a function, at least in part, of already-existing delivery assignments. At block 302, the control circuit 105 can then generate a list of available delivery resources by evaluating already-existing delivery assignments against the third set of rules.

The third set of rules can specify, for example, not including as an available delivery resource any candidate delivery resource having an already-existing delivery assignment that partially or wholly overlaps with any of the generated delivery blocks. As another example, the third set of rules can specify (in combination with the foregoing or in lieu thereof) not including as an available delivery resource any candidate delivery resource having more than a particular number of already-existing delivery assignments to thereby avoid overburdening any particular delivery resource regardless of whether the already-existing delivery assignments might overlap with any of the generated delivery blocks that remain to be assigned.

In lieu of the foregoing or in combination therewith, and referring now momentarily to FIG. 4, at block 401 the control circuit 105 can access a fourth set of rules that generates a list of preferred delivery resources as a function, at least in part, of available delivery resources, generated delivery blocks, and already-existing delivery assignments. So configured, the control circuit 105 can generate a list of preferred delivery resources by evaluating available delivery resources, generated delivery blocks, and already-existing delivery assignments against the fourth set of rules.

Referring again to FIG. 2, at block 205 the control circuit 105 accesses a list of available delivery resources and transmits future delivery opportunities to the available delivery resources on a delivery block-by-delivery block basis. Those transmissions can be delivered, for example, via the aforementioned network interface 108 and corresponding network(s) 109. By one approach, the drivers, dispatchers, or other responsible persons associated with the delivery resources 103 utilize a specific smart phone application that serves to receive such transmissions, to present the specific offered delivery blocks via, for example, a corresponding display, and to receive input from the user regarding acceptance or declination of specific delivery blocks. By one approach these delivery opportunities are published as Kafka topic events (presuming use of Apache Kafka, an open-source stream-processing software platform that is well known in the art).

Generally speaking, these teachings do not necessarily anticipate transmitting all generated delivery blocks as an opportunity available to each and every one of the available delivery resources. Instead, specific delivery blocks can be singularly offered to specific delivery resources.

At block 206, the control circuit 105 receives individual responses from various ones of the available delivery resources that comprise either of an acceptance or a declination of a corresponding one of the future delivery opportunities. To the extent that a particular delivery resource accepts a particular delivery block, that delivery block has an “assigned” status. To the extent that a particular delivery resource declines a particular delivery block, the control circuit 105 can reoffer that declined delivery block to another, different delivery resource until the delivery block is accepted.

So configured, upcoming anticipated delivery requirements for a given period of time are pre-assigned to available delivery resources. As actual orders are received and delivery needs become real, those deliveries can be apportioned amongst the assigned delivery blocks to thereby effect scheduling, including very near-term scheduling (such as, for example, within the next 30 or 60 minutes) of the corresponding deliveries.

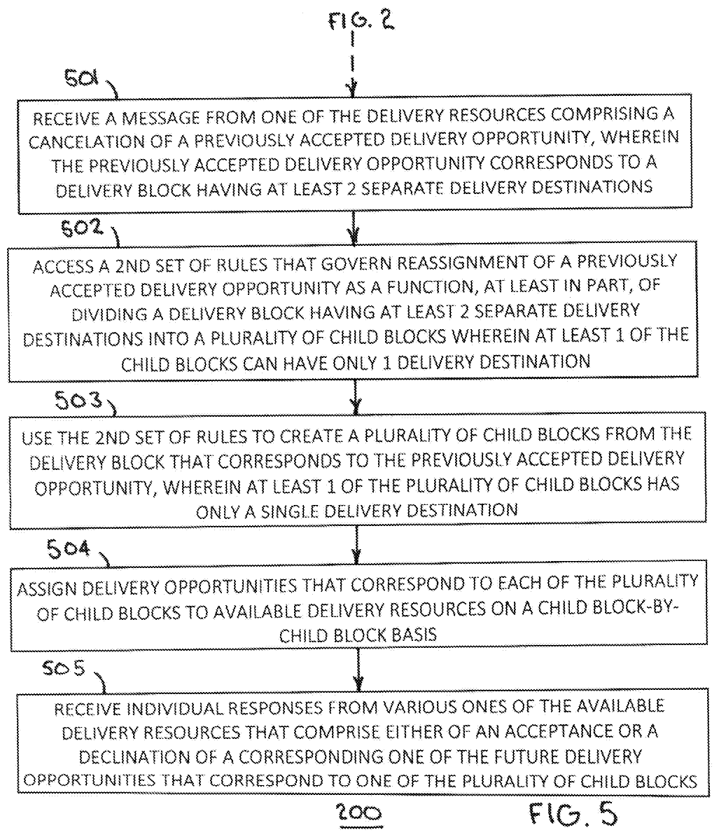

It is of course possible that an accepted delivery block might later be canceled by the corresponding delivery resource that originally accepted the delivery block. By one approach, the now-canceled delivery block can simply be reassigned by using the above-described procedures. When the canceled delivery block, however, corresponds to at least two separate delivery destinations, the situation can become considerably more complex (especially if time is short and/or the pool of available delivery resources is thin due to existing assignments). Referring to FIG. 5, the foregoing process 200 can accommodate such a circumstance in a manner that is now described.

At block 501, the control circuit 105 receives a message from one of the delivery resources comprising a cancellation of a previously accepted delivery opportunity, and in particular, a previously accepted delivery opportunity that corresponds to a delivery block having at least two separate delivery destinations.

In response to the foregoing, the control circuit 105, at block 502, accesses a second set of rules that govern reassignment of a previously accepted delivery opportunity as a function, at least in part, of dividing a delivery block having at least two separate delivery destinations into a plurality of child blocks wherein at least one of the child blocks can have only one delivery destination. In many cases, this second set of rules can provide for dividing the delivery block into a plurality of child blocks wherein each of the child blocks has only one delivery destination.

At block 503, the control circuit 105 uses this second set of rules to create a plurality of child blocks from the delivery block that corresponds to the previously accepted (and now canceled) delivery opportunity, wherein at least one of the plurality of child blocks has only a single delivery destination (and where, in perhaps a preferred approach, each of the plurality of child blocks as only a single delivery destination). This child block status/characterization can be stored in the metadata for the child block(s) if desired to thereby reflect this change.

At block 504, the control circuit 105 can then assign delivery opportunities that correspond to each of the plurality of child blocks so created to available delivery resources on a child block-by-child block basis. By one approach this assignment process can be essentially the same as was described above with respect to block 205 in FIG. 2. At block 505, the control circuit 105 receives individual responses from various ones of the available delivery resources that comprise either of an acceptance or a declination of a corresponding one of the future delivery opportunities that correspond to one of the plurality of child blocks.

So configured, this use of so-called child blocks, where at least some and perhaps all of the child blocks are each limited to only one delivery destination, can facilitate reassignment of delivery opportunities even when time and resources may be running short.

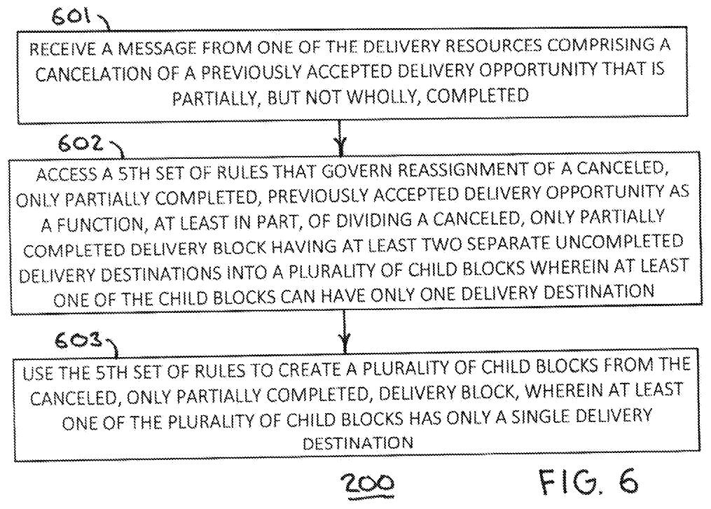

It is also possible that an accepted delivery block might later be canceled after being partially, but not wholly, completed by the corresponding delivery resource that originally accepted the delivery block. By one approach, the now-canceled partially-completed delivery block can simply be assigned by using the procedure described above in FIG. 2. FIG. 6 illustrates another approach, however, by which the foregoing process 200 can accommodate such a circumstance.

At block 601, the control circuit 105 receives a message from one of the delivery resources comprising a cancellation of a previously accepted delivery opportunity that is partially, but not wholly, completed (which is to say that at least one item 102 to be delivered pursuant to the corresponding delivery block has been delivered). This incomplete delivery block may have only one remaining delivery or may have two or more separate uncompleted delivery destinations.

At block 602 the control circuit 105 accesses a fifth set of rules that govern reassignment of a canceled, only partially completed, previously accepted delivery opportunity as a function, at least in part, of dividing a canceled, only partially completed delivery block having at least two separate uncompleted delivery destinations into a plurality of child blocks wherein at least one of the child blocks can have only one delivery destination. (In many application settings it may be preferred that the canceled, only partially completed delivery block be divided into a plurality of child blocks where each of the resultant child blocks has only one delivery destination.) At block 603 the control circuit 105 then uses that fifth set of rules to create a plurality of child blocks from the canceled, only partially completed, delivery block, wherein at least one (and potentially or preferably each) of the plurality of child blocks has only a single delivery destination. Assignment of these resultant child blocks can then proceed as described above for FIG. 5 at blocks 504 and 505.

So configured, these teachings serve as a platform that can maximize the customer experience by ensuring quality of service while minimizing delivery costs, at least in part, by choosing the right mix of delivery carriers. More particularly, these teachings provide for creating and matching supply (i.e., delivery drivers and working shifts) with corresponding demand (i.e., orders).

Further illustrative examples will now be provided. It shall be understood that the specifics of the following examples are again provided for the purposes of illustration and are not intended to suggest any particular limitations with respect to these teachings. Generally speaking, pursuant to these teachings and in these examples these approaches provide for forecasting the number of delivery blocks that are required to meet an order forecast, managing the state of delivery blocks from creation through acceptance/forfeiture, and managing the assignment of delivery drivers based on an availability schedule.

Per the foregoing teachings, the following calculations can be undertaken:
Calculate total trips required=Total orders in the block*max orders per trip
Total drive time for a block=Total orders in a block*average drive time per order
Total blocks required using driving time=Total drive time/number of orders in each delivery resource
Total blocks required using max orders=Total orders/number of orders in each delivery resource
Number of blocks required=Maximum of Total blocks required using drive time and total blocks using max orders
Price of a block=Time length of the block in hours*Hourly rate at the store

By one approach, customers can be promised particular delivery slots based on the capacity of these blocks. In any event, the foregoing document information can reflect a total number of blocks required for a given day, shift timing for each block, and block price.

The delivery resource assignment mechanism can be conducted as follows. The control circuit 105 can be provided with driver schedules for the relevant days as provided by drivers (via, for example, the aforementioned smart phone app) and identification/addressing information for contacting individual drivers. Then, for each block, the control circuit 105 can pick the first driver whose schedule matches with the block timing for a particular delivery block being assigned (which means the delivery block will totally be contained in the driver's schedule). Presuming this driver accepts the delivery opportunity, if the remaining time in that driver's schedule is more than the size of one block, then that driver will remain in the list of available drivers for the next block. Otherwise that driver will be excluded from the pool of available candidate delivery resources. The foregoing can continue until all blocks are assigned, no drivers remain, or the remaining unassigned blocks do not properly match with any driver schedule.

A simple illustrative example in these regards can presume the information shown below in Table 1 (for a facility denoted as “Store 5869”).

TABLE 1

| Store | Day | Slot | Orders |
|---|---|---|---|
| 5869 | Feb. 22, 2018 | 8-9 | 4 |
| 5869 | Feb. 22, 2018 | 9-10 | 3 |
| 5869 | Feb. 22, 2018 | 10-11 | 2 |
| 5869 | Feb. 22, 2018 | 11-12 | 1 |

| Store | 5869 | |
|---|---|---|
| Preferred Block Size | 2 | hour |
| Max orders per trip | 1 | |
| Average Travel Time | 30 | min |

Illustrative calculations for a first block of two hours that covers from 8 until 10 indicate that the number of trips that a single delivery resource can do in a single block is 2, that the total number of trips needed is 7, and therefore the total number of delivery resources needed is 7/2=3.5, which can be rounded up to 4.

An illustrative data model for a given delivery block appears in Table 2 shown below.

TABLE 2
Block:

| | | | | | | | | | |
|---|---|---|---|---|---|---|---|---|---|
| | | | | | | | | | driver_ |
| id | store_ | start_ | end_ | price_ | maximum_ | maximum_ | maximum_ | | id |
| Auto- | id | datetime | datetime | usd | weight | volume | capacity | status | suitable |
| Generated | Int | datetime | datetime | int | int | int | int | varchar | int |

```
{
  “payload”: {
    “createdBy”: “xvz”
      “modifiedBy”: “xvz”
      “courierType”: “Flex”
      “storeId”: “${dspName}”, // <-- 4 digit walmart code like 5337
      “blocks”: {
        {
          “blockId”: “${UUID}”,
          “shiftStart”: “2017-10-6T13 ; 00:00-07:00”, // <-- should be in same tz as dsp
tz
          “shiftEnd”: “2017-10-6T23 ; 45:56-07:00”, // <-- should be in same tz as dsp tz
          “maximumWeight” : 5000,
          “maximumVolume” : 6000,
          “maximumCapacity” : 7000,
          “price”: “${price}”
        }
      }
    }
}
```

A data model for a corresponding forecast table appears in Table 3 shown below.

TABLE 3
Forecast Table

| store_id | date | slot_starttime | slot_endtime | orders | duration |
|---|---|---|---|---|---|
| Int | date | datetime | datetime | int | int |

An illustrative data model for configuration information appears in Table 4 shown below.

TABLE 4

| store_id | preferred_block_size | max_ orders_per_vehicle | average_travel_time_per_order | per_hour_block_price |
|---|---|---|---|---|
| int | Int | datetime | datetime | int |

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method to facilitate automatically scheduling delivery resources for a first facility having items to deliver, comprising:
by a control circuit:
accessing a first set of rules that define a number of delivery blocks as a function, at least in part, of delivery forecast information for a given facility, characterizing information for the delivery resources, and delivery parameters corresponding to the given facility;
accessing delivery forecast information for items at the first facility spanning a predetermined window of time;
generating a plurality of delivery blocks for at least a portion of the predetermined window of time by evaluating the delivery forecast information for items at the first facility against the first set of rules, wherein at least one of the plurality of delivery blocks provides for deliveries of items from the facility to at least two separate delivery destinations;
accessing a list of available delivery resources and transmitting future delivery opportunities to the available delivery resources on a delivery block-by-delivery block basis;
receiving individual responses from various ones of the available delivery resources that comprise either of an acceptance or a declination of a corresponding one of the future delivery opportunities;
receiving a message from one of the delivery resources comprising a cancellation of a previously accepted delivery opportunity, wherein the previously accepted delivery opportunity corresponds to a delivery block having at least two separate delivery destinations;
accessing a second set of rules that govern reassignment of a previously accepted delivery opportunity as a function, at least in part, of dividing a delivery block having at least two separate delivery destinations into a plurality of child blocks wherein at least one of the child blocks can have only one delivery destination;
using the second set of rules to create a plurality of child blocks from the delivery block that corresponds to the previously accepted delivery opportunity, wherein at least one of the plurality of child blocks has only a single delivery destination;
assigning delivery opportunities that correspond to each of the plurality of child blocks to available delivery resources on a child block-by-child block basis;
receiving individual responses from various ones of the available delivery resources that comprise either of an acceptance or a declination of a corresponding one of the future delivery opportunities that correspond to one of the plurality of child blocks.

2. The method of claim 1 wherein the delivery forecast information comprises a forecast of how many of the items will need to be delivered from the first facility during the predetermined window of time.

3. The method of claim 2 wherein the delivery forecast information comprises a forecast of how many of the items will need to be delivered from the first facility during the predetermined window of time on a per diem basis.

4. The method of claim 1 wherein the characterizing information for the delivery resources comprises at least one of:
an average number of items that can be simultaneously carried by a representative delivery resource;
a maximum volume of contents that can be simultaneously carried by the representative delivery resource;
a maximum weight of contents that can be simultaneously carried by the representative delivery resource.

5. The method of claim 1 wherein the delivery parameters corresponding to the given facility comprise at least one of:
a first parameter representing an average length of time to complete a delivery of an item from the first facility;
a second parameter representing a maximum number of deliveries per delivery block.

6. The method of claim 1 further comprising:
accessing a third set of rules that vets delivery resources to identify available delivery resources as a function, at least in part, of already-existing delivery assignments;
generating the list of available delivery resources by evaluating already-existing delivery assignments against the third set of rules.

7. The method of claim 1 further comprising:
accessing a fourth set of rules that generates a list of preferred delivery resources as a function, at last in part, of available delivery resources, generated delivery blocks, and already-existing delivery assignments;
and wherein accessing the list of available delivery resources and transmitting future delivery opportunities to the available delivery resources on a delivery block-by-delivery block basis comprises, at least in part, generating a list of preferred delivery resources by evaluating available delivery resources, generated delivery blocks, and already-existing delivery assignments against the fourth set of rules and transmitting the future delivery opportunities to delivery resources from the list of preferred delivery resources.

8. The method of claim 7 wherein the fourth set of rules provide for allowing an available delivery resource to be considered a preferred delivery resource for a given delivery block so long as the available delivery resource has unscheduled available time that overlaps at least in part with the given delivery block.

9. The method of claim 1 wherein generating the plurality of delivery blocks comprises providing, for each of the delivery blocks, a corresponding unique block identifier.

10. The method of claim 1 further comprising maintaining, for each of the generated delivery blocks, a status indicator, wherein the status indicator indicates, at least in some cases, a usage status.

11. The method of claim 1 wherein the second set of rules provide for dividing a delivery block having at least two separate delivery destinations into a plurality of child blocks wherein each of the child blocks has only one delivery destination.

12. The method of claim 11 wherein the control circuit is configured to use the second set of rules to create the plurality of child blocks from the delivery block that corresponds to the previously accepted delivery opportunity, wherein each of the plurality of child blocks has only a single delivery destination.

13. The method of claim 1 further comprising:
receiving a message from one of the delivery resources comprising a cancellation of a previously accepted delivery opportunity that is partially, but not wholly, completed.

14. The method of claim 13 wherein the partially but not wholly completed canceled delivery opportunity includes at least two separate uncompleted delivery destinations.

15. The method of claim 14 further comprising:
accessing a fifth set of rules that govern reassignment of a canceled, only partially completed, previously accepted delivery opportunity as a function, at least in part, of dividing a canceled, only partially completed delivery block having at least two separate uncompleted delivery destinations into a plurality of child blocks wherein at least one of the child blocks can have only one delivery destination;
using the fifth set of rules to create a plurality of child blocks from the canceled, only partially completed, delivery block, wherein at least one of the plurality of child blocks has only a single delivery destination.
